(19) United States
(12) Patent Application Publication
(10) Pub. No.: US 2025/0354819 A1
(43) Pub. Date: Nov. 20, 2025

(54) DATA SERVER, NAVIGATION TERMINAL, AND METHOD OF PROVIDING CONGESTION INFORMATION OF VEHICLE ACCESS ROADS

(71) Applicants: Hyundai Motor Company, Seoul (KR); Kia Corporation, Seoul (KR)

(72) Inventor: Jeong Seog Yang, Hwaseong (KR)

(21) Appl. No.: 18/940,034

(22) Filed: Nov. 7, 2024

(30) Foreign Application Priority Data
May 17, 2024 (KR) 10-2024-0064276

(51) Int. Cl. G01C 21/34; G08G 1/01; G08G 1/0967

(52) U.S. Cl. CPC G01C 21/3492; G08G 1/012; G08G 1/0133; G08G 1/096775

(57) ABSTRACT

A navigation terminal for providing congestion information based on a vehicle connectivity environment includes a data transceiver that requests and receives congestion information including a congested area for an access road from a data server when entering an information request area for the access road, a guidance control module that determines whether a length of the congested area with respect to the access road is less than a length of a guidance area and controls an output of access road guidance information at different points according to the length of the congested area, based on a determination result of the guidance control module, and a guidance information output module that outputs guidance information regarding the access road according to control of the guidance control module.

### CROSS-REFERENCE TO RELATED APPLICATION(S)

This application claims under 35 U.S.C. § 119(a) the benefit of Korean Patent Application No. 10-2024-0064276 filed on May 17, 2024 in the Korean Intellectual Property Office, the entire contents of which are incorporated herein by reference.

### BACKGROUND

### (a) Technical Field

The present disclosure relates to a data server and a navigation terminal for providing congestion information on access roads based on a vehicle connectivity environment, and to a method of providing congestion information on access roads.

### (b) Description of the Related Art

Generally, a navigation system for providing road information may be installed in an electronic device such as a vehicle information system or smartphone, and may provide various types of information regarding the road being driven on or a user selected road.

While driving, in the case in which there is an exit (or access road) for exiting a road such as a highway or an entrance (or access road) to access a road such as a highway, existing navigation systems may output guidance on road entrances and exits when a predetermined distance from an entrance or exit road is reached.

For example, when performing destination guidance, existing navigation systems may provide destination guidance or provide guidance to turn right or left several kilometers ahead of a turn, when reaching a designated point a certain distance away from the entrance or exit road, to enter an access road of the road on which a vehicle is travelling.

However, due to road conditions, such as habitually congested sections of road or congested sections of road during commuting times, there may be cases in which road access routes are congested even before guidance information on the road access routes is provided. Therefore, drivers who are not aware of this situation in advance, such as beginner drivers, may inevitably have to intervene. Accordingly, there is a problem in which drivers may encounter unsafe situations such as contact accidents or collision accidents due to unreasonable interruption in the middle of the queue.

### SUMMARY

The present disclosure provides a data server and a navigation terminal for providing congestion information on access roads (e.g., highway off-ramps and exit roads) based on a vehicle connectivity environment that may provide information regarding a queue on the on the road off-ramps and exit road before the queue (or congestion line) starts due to congestion on the road entrances and exits, by sensing in advance a situation on road entrances and exits guided in the vehicle connectivity environment, and to provide a method of providing congestion information on road entrances and exits.

According to an aspect of the present disclosure, a data server for providing congestion information on entrance and exit roads based on a vehicle connectivity environment includes a data collection module collecting sensing information including location information regarding a sensing target vehicle to pass through an access road and vehicle congestion determination information, from sensing vehicles sensing the access road among vehicles before a reference position of the access road; a congestion information generation module determining a congested area with respect to the access road based on the vehicle congestion determination information included in the sensing information, and generating the congestion information including congested area information; and a data transmission module transmitting the congestion information in response to a request for information regarding the access road.

The data collection module may be configured to include at least one of a first data collection module collecting first sensing information including the location information regarding the sensing target vehicle to pass through the access road and the vehicle congestion determination information, from sensing vehicles that do not pass through the access road among the vehicles positioned before the reference position of the access road, and a second data collection module collecting second sensing information including location information regarding a driver's vehicle and the vehicle congestion determination information.

The congestion information generation module may be configured to include at least one of a first congestion information generator determining the congested area with respect to the access road based on the vehicle congestion determination information included in the first sensing information and generating first congestion information including the congested area information, and a second congestion information generator determining the congested area with respect to the access road based on the second sensing information and generating second congestion information including the congested area.

The data transmission module may be configured to transmit at least one of the first congestion information and the second congestion information as the congestion information in response to the request for information regarding the access road, or to transmit congestion information based on the first congestion information and the second congestion information.

The first congestion information generator be configured to determine a congested vehicle on the access road based on location information and vehicle congestion determination information for each of sensing target vehicles included in the first sensing information, and to determine the congested area, based on vehicle(s) determined to be the congested vehicle.

The second congestion information generator may be configured to determine a congested vehicle on the access road based on location information and vehicle congestion determination information for each of sensing vehicles included in the second sensing information, and to determine the congested area, based on vehicle(s) determined to be the congested vehicle.

According to an aspect of the present disclosure, a navigation terminal for providing congestion information on entrance and exit roads based on a vehicle connectivity environment includes a data transceiver requesting and receiving congestion information including a congested area with respect to an access road from a data server when entering an information request area for the access road; a guidance control module determining whether a length of the congested area with respect to the access road is less than a length of a guidance area and controlling an output of access road guidance information at different points according to the length of the congested area, based on a determination result of the guidance control module; and a guidance information output module outputting guidance information regarding the access road according to control of the guidance control module.

The guidance control module may be configured to include a comparison module comparing the length of the congested area with respect to the access road and the length of the guidance area; and a control module controlling an output of first access road guidance information when entering the guidance area when the length of the congested area is less than the length of the guidance area as a result of the comparing, and controlling an output of second access road guidance information at a point of entry into a new guidance area determined using the length of the congested area and the length of the guidance area when the length of the congested area is greater than or equal to the length of the guidance area.

The control module may be configured to control the output of the second access road guidance information at the point of entry into the new guidance area determined by adding the length of the congested area to the length of the guidance area when the length of the congested area is greater than or equal to the length of the guidance area.

The data transceiver may be configured to further include a memory updating congestion information on a corresponding access road when the congestion information including the congested area is transmitted from the data server.

A vehicle may include the navigation terminal.

According to an aspect of the present disclosure, a method of providing congestion information on access roads based on a vehicle connectivity environment includes an information request area determination operation of determining whether to enter an information request area for an access road; a congestion information receiving operation of receiving the congestion information by requesting information regarding the access road from a data server when entering the information request area; a guidance point confirmation operation of determining a guidance area by comparing a length of a congested area included in the congestion information for the access road with a length of the guidance area, and confirming entry into the guidance area determined; and a guidance information output operation of outputting guidance information regarding the access road depending on an entry into the guidance area or not.

The method of providing congestion information on access roads based on a vehicle connectivity environment may be configured to further include a congestion information transmission operation of transmitting, by the data server, congestion information, including a congested area, prepared in advance for a corresponding access road, in response to a request for the congestion information for each access road by a navigation terminal.

The congestion information transmission operation may be configured to include a data collection operation of collecting, by the data server, sensing information including location information regarding a sensing target vehicle to pass through the access road and vehicle congestion determination information, from sensing vehicles sensing the access road among vehicles before reaching a reference position of the access road; a congestion information generation operation of determining the congested area with respect to the access road based on the vehicle congestion determination information included in the sensing information, and generating the congestion information including congested area information; and a data transmission operation of transmitting the congestion information in response to a request for information regarding the access road.

The data collection operation may be performed by collecting first sensing information including the location information regarding the sensing target vehicle to pass through the access road and the vehicle congestion determination information, from sensing vehicles that do not pass through the access road among the vehicles positioned before the reference position of the access road, or collecting second sensing information including location information regarding a driver's vehicle and the vehicle congestion determination information from sensing vehicles to pass through the access road.

The congestion information generation operation may include determining the congested area with respect to the access road based on the vehicle congestion determination information included in the first sensing information and generating first congestion information including the congested area information, or determining the congested area with respect to the access road based on the second sensing information and generating second congestion information including the congested area.

The data transmission operation may include transmitting at least one of the first congestion information and the second congestion information as the congestion information in response to the request for information regarding the access road, or transmitting congestion information based on the first congestion information and the second congestion information.

The method of providing congestion information on access roads may further include an access-road speed sensing operation of sensing, by respective sensing vehicles sensing a vehicle speed on the access road, speeds of respective vehicles advancing on the access road or a speed of a driver's vehicle when entering a sensing area for the access road, comparing a sensed speed with a congestion reference speed, determining a congested vehicle or an uncongested vehicle depending on comparison result information, and transmitting the congestion information including determination information on the congested vehicle to the data server.

The guidance point confirmation operation may include a determination operation of determining whether the length of the congested area with respect to the access road is less than the length of the guidance area; and a control operation of controlling an output of first access road guidance information when entering the guidance area when the length of the congested area is less than the length of the guidance area, and controlling an output of second access road guidance information at a point of entry into a new guidance area determined using the length of the congested area and the length of the guidance area when the length of the congested area is greater than or equal to the length of the guidance area.

The control operation may control the output of the second access road guidance information in a new guidance area determined by adding the length of the congested area to the length of the guidance area, when the length of the congested area is greater than or equal to the length of the guidance area.

The congestion information receiving operation may further include a congestion information update operation of updating the congestion information for a corresponding access road when a navigation terminal receives the congestion information including the congested area from the data server.

In addition, aspects of the present disclosure are not limited to the aspects exemplified above, and other aspects may be additionally understood in the process described below.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic diagram of a device for providing congestion information on an access road of the road based on a vehicle connectivity environment according to an embodiment;

FIG. 2 is an example diagram of a data server;

FIG. 3 is an illustrative diagram for navigation guidance on road entrances and exits;

FIG. 4 is another example diagram of the data server of FIG. 2;

FIG. 5 is an illustrative diagram of the congestion point and queue in the access road;

FIG. 6 is an illustrative diagram of a navigation terminal of FIG. 1;

FIG. 7 is an illustrative diagram of a guidance control module of FIG. 6;

FIG. 8 is an illustrative diagram of a comparison module and a control module of a guidance control module of FIG. 6;

FIGS. 9A and 9B are illustrative diagrams of guidance information from a guidance information output module;

FIG. 10 is another example diagram of a navigation terminal of FIG. 1;

FIG. 11 is a flowchart illustrating a method of providing congestion information on road entrances and exits based on a vehicle connectivity environment according to an embodiment;

FIG. 12 is an example diagram of a congestion information transmission operation;

FIG. 13 is an example diagram of a detailed operation of the congestion information transmission operation of FIG. 12;

FIG. 14 is an example diagram of an access road speed sensing operation;

FIG. 15 is another example diagram of the access road speed sensing operation;

FIG. 16 is an example diagram of a guidance point confirmation operation of FIG. 11;

FIG. 17 is an example diagram of a control operation of FIG. 16;

FIG. 18 is an example diagram of a congestion information update operation; and

FIG. 19 is a block diagram of a computing device that may fully or partially implement a device and method of providing congestion information on road entrances and exits based on a vehicle connectivity environment according to an embodiment.

In the drawings and detailed description, like reference numerals refer to like elements. Drawings may not be to scale and the relative sizes, proportions and depictions of drawing elements may be exaggerated for clarity, illustration and convenience.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “module”, “-er”, “-or”, and “module” described in the specification mean modules for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, detailed embodiments will be described with reference to the drawings. The detailed description below is provided to facilitate a comprehensive understanding of the methods, devices and/or systems described herein. However, this is only an example and the present disclosure is not limited thereto.

In describing embodiments, detailed descriptions of known technologies related to the present disclosure will be omitted if it is judged that such detailed descriptions may unnecessarily obscure the gist of the present disclosure. The terms described below are defined in consideration of the functions in the present disclosure, and may vary depending on the intention or custom of the user or operator. Therefore, the definition should be made based on the contents throughout this specification. The terminology used in the detailed description is only for describing embodiments and should in no way be limiting. Unless explicitly stated otherwise, expressions in the singular form include the meaning in the plural form. In this description, expressions such as “including” or “provided” are intended to indicate certain features, numbers, operations, operations, elements, parts or combinations thereof, and it should not be construed to exclude the existence or possibility of one or more other features, numbers, operations, operations, elements, or parts or combinations thereof, other than those described.

Hereinafter, embodiments will be described in more detail with reference to the attached drawings.

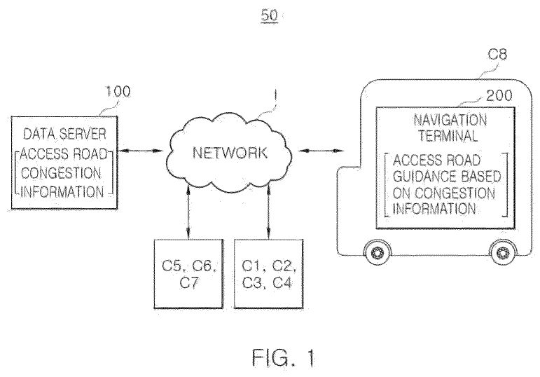

FIG. 1 is a schematic diagram of a device for providing congestion information on access roads based on a vehicle connectivity environment according to an embodiment.

Referring to FIG. 1, a device 50 for providing congestion information on access roads based on vehicle connectivity environment according to an embodiment may include a data server 100 and a navigation terminal 200 connected to a network 1.

The network 1 may include various communication networks required to build a vehicle connectivity environment. For example, various communication networks may include at least one of Internet, wireless telephone network, wireless traffic communication network, cloud wireless access network, satellite communication network, and the like for connecting various devices such as smartphones, external vehicles, transportation infrastructure, and smart homes with the data server 100 and navigation terminal 200.

The data server 100 may be connected to the navigation terminal 200 through the network 1, and may transmit congestion information CI, including pre-prepared congested areas CA for the corresponding access road, in response to a request for congestion information CI for each entry/exit route on the road. For example, a road may be a highway, but is not limited thereto. The access road may be an exit road from a road such as a highway or an entry road to a road such as a highway.

For example, the data server 100 may collect congestion information for each entrance and exit of the road, in detail, information regarding the access road, from each of sensing vehicles C5, C6 and C7 unrelated to the access road and/or sensing vehicles C2, C3 and C4 exiting to the access road, may generate congestion information CI including congested areas for the access road, based on this collected information, and may store generated information in an internal memory (not illustrated).

The navigation terminal 200 may be connected to the data server 100 through the network 1 during navigation execution (navigation program execution), and when entering an information request area RA for the road access road, the navigation terminal 200 may request information regarding the access road from the data server 100 and receive congestion information CI, and may output guidance information for the access roads depending on whether to enter this guidance area or not by comparing the length of the congested area CA and the length of the guidance area GA included in the congestion information CI for the access road.

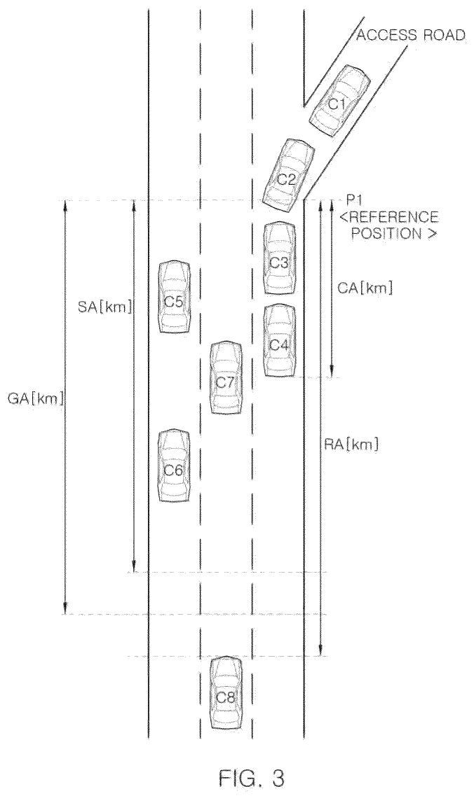

In this disclosure, the navigation terminal 200 is described as a terminal mounted on a vehicle C8 (see FIG. 3), but this is only for convenience of explanation and understanding and is not limited thereto. As another example, the navigation terminal 200 may be mounted in mobile devices such as smartphones and the like in addition to vehicles.

On the other hand, the vehicle connectivity environment refers to a vehicle environment equipped with a network system that allows real-time two-way communication of data generated while moving with various connection targets through network connections based on the Internet and cloud services.

For respective drawings of the present disclosure, unnecessarily redundant descriptions of components with the same symbols and the same function may be omitted, and possible differences between the drawings may be explained.

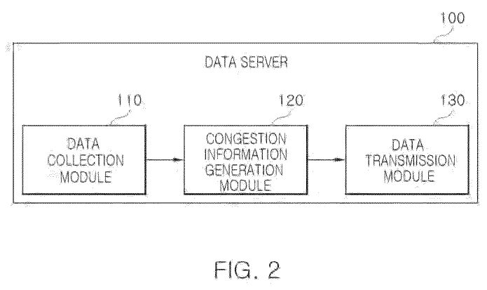

FIG. 2 is an example diagram of a data server.

Referring to FIG. 2, the data server 100 may include a data collection module 110, a congestion information generation module 120, and a data transmission module 130.

The data collection module 110 may collect sensing information SI10 including location information for sensing target vehicles C1, C2, C3 and C4 that will pass through the access road and information on determining congested vehicles, from the sensing vehicles C1 to C4 and C5 to C7 that sense the access road among vehicles positioned before the reference position of the access road. For example, the location information may be location coordinate information, and the vehicle congestion determination information may be information regarding whether the vehicle is a congested vehicle or an uncongested vehicle.

The congestion information generation module 120 determines the congested area CA for the access road, based on the congestion vehicle based on the vehicle congestion determination information included in the sensing information SI10, and may generate congestion information CI10 including the congested area CA.

For example, among the sensing target vehicles C1, C2, C3 and C4, in the sensing target vehicles C2, C3 and C4 after the reference position P1 of the access road, in the case in which vehicles C2, C3, and C4 are congested vehicles, the congestion length CA may correspond to the length from the location of vehicle C2 to the location of vehicle C4. The congested area CA may include the corresponding exit route information, and the starting location of the congested area (for example, location of vehicle C2) to the ending location of the congested area (for example, location of C4, the last congested vehicle).

In addition, the data transmission module 130 may transmit the first congestion information CI10 to the requested navigation terminal 200 in response to a request for information regarding the access road transmitted from the navigation terminal 200 through the network 1.

In the present disclosure, the data collection module 110, the congestion information generation module 120, and the data transmission module 130 may respectively be implemented as separate processors. Alternatively, the data collection module 110, the congestion information generation module 120, and the data transmission module 130 may be implemented with one processor, and there is no need to be limited to any one thereof.

FIG. 3 is an illustrative diagram for navigation guidance on an access road.

Referring to FIG. 3, while performing road guidance in navigation, if there is a target entrance/exit route to pass through on the route to the destination, the navigation terminal 200 may perform pre-designated guidance based on information regarding CA, information regarding SA, information regarding GA, and information regarding RA, which is based on the reference position P1 of the target access road.

For example, CA [for example, km] is the congested area (congestion point (congestion start point) to congestion end point (=reference position)) determined by the congested vehicle among the vehicles that will pass through the access road. As an example, information regarding the congested area CA may include information regarding the corresponding entry, and location coordinate information regarding the congestion start point (congestion point), and the congestion end point.

SA [for example, km] is a sensing area (sensing point to sensing end point) where sensing vehicles C5, C6 and C7 that do not pass through the access road perform sensing for vehicles C1, C2, C3 and C4 that will pass through the access road. As an example, information regarding the sensing area SA may include information regarding the entry, location coordinate information regarding the sensing start point (sensing point), and the sensing end point.

GA [e.g., km] is a guidance area that provides guidance on the access road in navigation. As an example, information regarding the guidance area GA may include information regarding the corresponding entry, and location coordinate information regarding the guidance start point (guidance point) and the guidance end point.

In addition, RA [e.g., km] is an information request area (information request start point to information request end point) that is connected to the data server 100 and may request congestion information CI for the access road to be passed. As an example, information regarding the information request area RA may include location coordinate information regarding the request start point (request point) and the request end point.

For example, the reference position P1 of the target access road refers to the position where the access road starts, as illustrated in FIG. 3, and may be appropriately determined by considering the shape, structure, or characteristics of each access road. The target access road is an access road included in the navigation route that guides the destination, and refers to the access road through which the vehicle C8 equipped with the navigation terminal 200 of the present disclosure will pass.

In addition, each of the congested area CA, sensing area SA, guidance area GA, and information request area RA for the target access road may have a value determined in advance for each access road, and in contrast, may have a value that may be varied by considering various variables such as time, congestion, road conditions, re-vehicle speed, and the like.

The access road in FIG. 3 is a route from the road to the outside, and thus, may be an exit route. In FIG. 3, the access road is illustrated on the right, but the present disclosure is not limited thereto, and the access road may be on the left side of a road such as a highway.

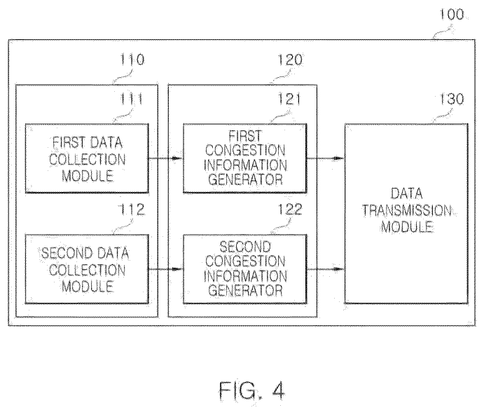

FIG. 4 is another example diagram of the data server of FIG. 2.

Referring to FIG. 4, the data collection module 110 may include at least one of a first data collection module 111 and a second data collection module 112.

The first data collection module 111 may collect first sensing information including location information regarding the sensing target vehicle that will pass through the access road and vehicle congestion determination information, from sensing vehicles that will not pass through the access road, among vehicles before the reference position of the access road.

The second data collection module 112 may collect second sensing information including location information regarding the driver's vehicle and vehicle congestion determination information from sensing vehicles that will pass through the access road.

Additionally, the congestion information generation module 120 may include at least one of a first congestion information generator 121 and a second congestion information generator 122.

The first congestion information generator 121 may determine the congested area CA for the access road based on the congestion vehicle based on the vehicle congestion determination information included in the first sensing information SI10, and may generate first congestion information CI10 including the congested area CA.

For example, among the sensing target vehicles C1, C2, C3 and C4, when the C2 vehicle, C3 vehicle, and C4 vehicle are congestion vehicles in the sensing target vehicles C2, C3 and C4 after the reference position P1 of the access road, the congestion length CA may correspond to the length from the location of the C2 vehicle to the location of the C4 vehicle. The congested area CA may include the corresponding exit route information, for example, the starting location of the congested area (for example, location of vehicle C2) to the ending location of the congested area (for example, location of C4, the last congested vehicle).

The second congestion information generator 122 may determine the congested area CA for the access road based on the second sensing information SI20, and may generate second congestion information CI20 including the congested area CA.

For example, among the sensing target vehicles C1, C2, C3 and C4, in the case in which the vehicle C2 and C3 are congested vehicles in the sensing congestion vehicles C2, C3 and C4 after the reference position P1 of the access road, the congestion length CA may correspond to the length from the location of vehicle C2 to the location of vehicle C3. The congested area CA may include the corresponding exit route information, the start location of the congested area (for example, location of vehicle C2), and the end location of the congested area (for example, location of C3, the last vehicle in congestion).

In addition, the data transmission module 130 may transmit at least one of the first congestion information and the second congestion information as congestion information in response to a request for information regarding the access road, or transmit congestion information based on the first congestion information and the second congestion information.

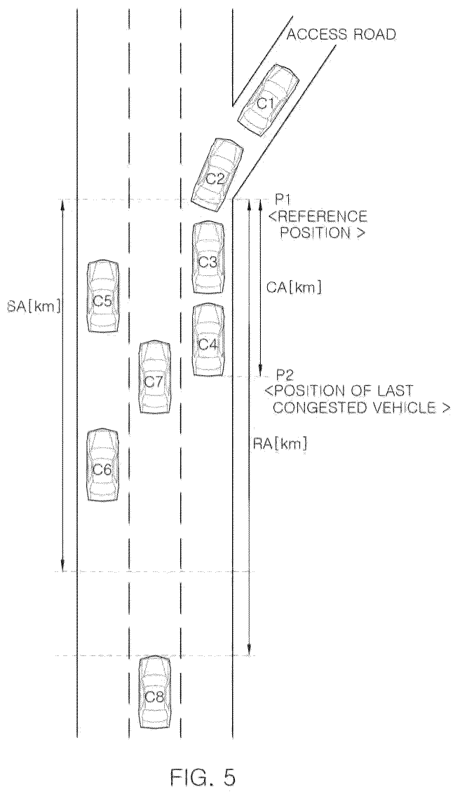

FIG. 5 is an illustrative diagram of the congestion point and queue in the access road.

Referring to FIGS. 2, 3, and 5, the first congestion information generator 121 may determine the congestion of vehicles on the access road, based on the location information for each of the sensing target vehicles C1, C2, C3 and C4, and vehicle congestion determination information, included in the first sensing information SI10, and may determine the congested area CA based on the vehicle(s) determined to be congested. For example, as illustrated in FIG. 5, when the last congested vehicle is C4, the congested area CA may be determined from the reference position P1 to the position of C4, which is the last congested vehicle, among the sensing target vehicles.

Referring to FIGS. 3, 4, and 5, the second congestion information generator 122 may determine a congested vehicle on the access road based on location information for each of the sensing target vehicles C1, C2, C3 and C4 and vehicle congestion determination information included in the second sensing information, and may determine the congested area CA based on the vehicle(s) determined to be congested. For example, unlike FIG. 5, when the last congested vehicle is C3, the congested area CA may be determined from the reference position P1 to the position of C3, which is the last congested vehicle, among the sensing target vehicles.

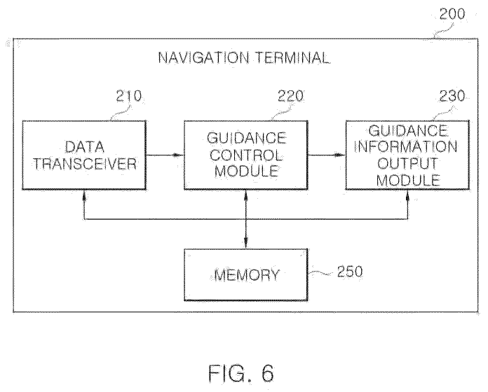

FIG. 6 is an example diagram of the navigation terminal of FIG. 1.

Referring to FIG. 6, the navigation terminal 200 may include a data transceiver 210, a guidance control module 220, a guidance information output module 230, and a memory 250.

When entering the information request area RA for the access road, the data transceiver 210 may request information including a congested area CA for the access road from the data server 100 and receive congestion information CI in response to this request. For example, the data server 100 may transmit pre-collected congestion information regarding the access road to the navigation terminal 200 in response to the request.

The guidance control module 220 may determine whether the length of the congested area CA for the access road is less than the length of the guidance area GA, and based on this determination result, may control the output of access road guidance information at different points according to the length of the congested area. As an example, the guidance control module 220 may include at least one processor.

The guidance information output module 230 may output guidance information regarding the access road under the control of the guidance control module 220.

In addition, the memory 250 may store various information related to navigation, such as navigation programs, map information, and information generated while the navigation program is running. Additionally, the memory 250 may include congestion information CI having information regarding the congested area CA for each access road included in the map.

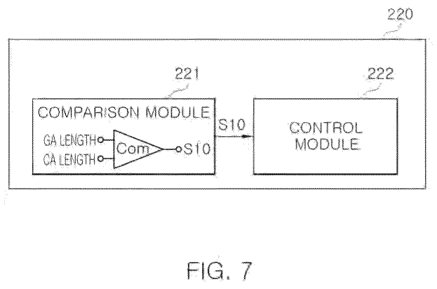

FIG. 7 is an example diagram of the guidance control module of FIG. 6.

Referring to FIG. 7, the guidance control module 220 may include a comparison module 221 and a control module 222.

The comparison module 221 may compare the length of the congested area CA and the length of the guidance area GA for the access road, and output a comparison signal S10 containing information according to the comparison result to the control module 222. As an example, the comparison module 221 may include a comparator Com that may compare the length of the congested area CA and the length of the guidance area GA and output a comparison signal.

The control module 222 may control output of first access road guidance information when entering the guidance area GA, based on the comparison signal S10 from the comparison module 221, if the length of the congested area CA is less than the length of the guidance area GA. Additionally, the control module 222 may control the output of second access road guidance information at the point of entry into a new guidance area (GA+CA) determined using the length of the congested area CA and the length of the guidance area GA, if the length of the congested area CA is greater than or equal to the length of the guidance area GA. For example, the control module 222 may include one processor.

As an example, the entry point into the new guidance area (GA+CA) may be the guidance point, and this guidance point may be determined to be longer than the length of the preset guidance area GA by adding an additional length using the length of the preset congestion area CA to the length of the preset guidance area GA. As an example, the additional length may be the length of the congested area CA, or may be a length (for example, CA/2 or 2*CA) using the length of the congested area CA in addition to the length of the congested area CA.

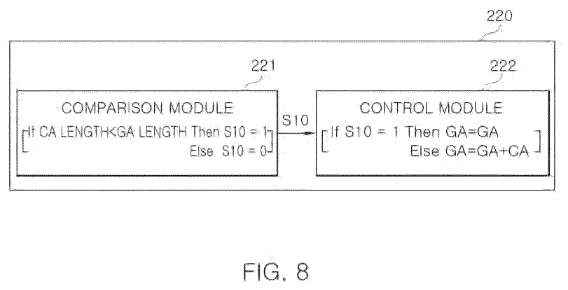

FIG. 8 is an example diagram of the comparison module and the control module of the guidance control module of FIG. 6.

Referring to FIG. 8, for example, the comparison module 221 may compare whether the length of the guidance area GA for the access road is longer than or equal to the length of the congested area CA, and if the length of the guidance area GA is greater than or equal to the length of the congested area CA, the comparison module 221 may output a comparison signal S10 having a high level (logic ‘1’), and in contrast, if the length of the guidance area GA is not greater than the length of the congested area CA, the comparison module 221 may output may output the comparison signal S10 having a low level (logic ‘0’).

In addition, the control module 222 receives a comparison signal S10 from the comparison module 221, and, based on the comparison signal S10, if the length of the guidance area GA is greater than or equal to the length of the congested area CA (when S10 is logic ‘1’), the control module 222 may maintain the existing guidance area GA as is, and may control the output of the first access road guidance information at the point of entry into the existing guidance area GA.

Alternatively, the control module 222 receives the comparison signal S10 from the comparison module 221, and based on the comparison signal S10, if the length of the congested area CA is greater than or equal to the length of the guidance area GA (when S10 is logic ‘0’), the control module 222 may control the output of the second access road guidance information at the point of entry into the new guidance area (GA+CA) determined by adding the length of the congested area CA to the length of the guidance area GA.

In the present disclosure, the level of the comparison signal S10 is just an example for convenience of explanation and understanding, and thus the present disclosure is not limited to the above example, and may be the opposite level, and the level of the comparison signal S10 may be a voltage level.

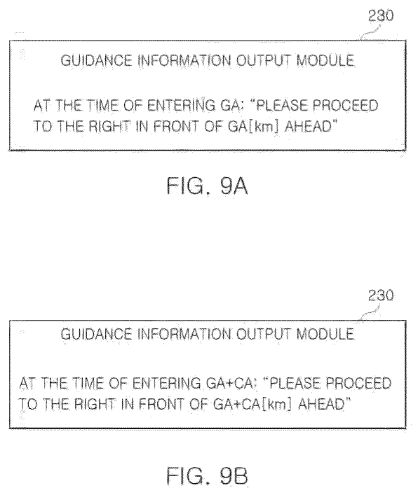

FIGS. 9A and 9B are examples of guidance information from the guidance information output module.

Referring to FIG. 9A, if the length of the congested area CA is less than the length of the guidance area GA, the guidance information output module 230 may output the first access road guidance information when entering the guidance area GA. For example, the first access road guidance information may be “Please proceed to the right in front of GA [km] ahead.”

Referring to FIG. 9B, if the length of the congested area CA is greater than or equal to the length of the guidance area GA, the guidance information output module 230 may output the second access road guide information in a new guidance area (for example, GA+CA) determined by adding the length of the congested area CA to the length of the guidance area GA.

For example, the second access road guidance information may be “Please proceed to the right in front of GA+CA [km] ahead”.

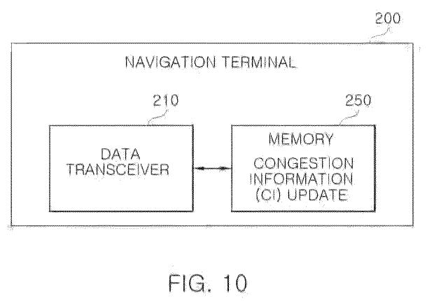

FIG. 10 is another example diagram of the navigation terminal of FIG. 1.

Referring to FIG. 10, when the data transceiver 210 receives requested congestion information CI including the congested area CA for the access road from the data server 100, the data transceiver 210 may update the memory 250 using congestion information CI for the access road.

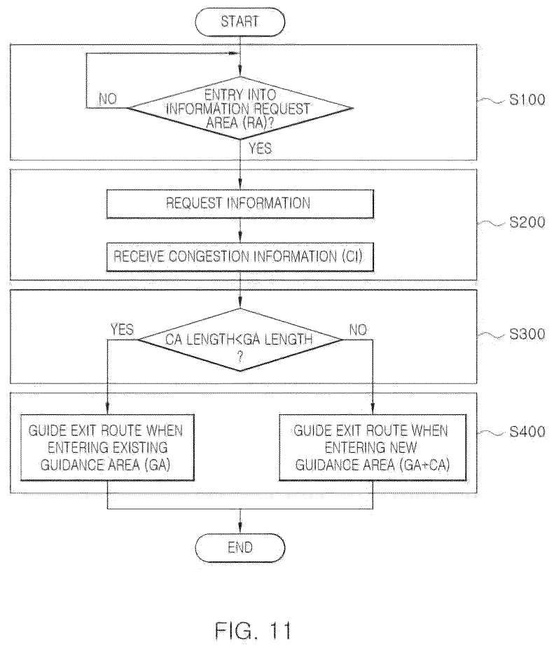

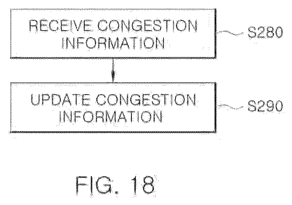

Next, with reference to FIGS. 11 and 18, a method of providing congestion information on road entrances and exits based on the vehicle connectivity environment will be described. In this disclosure, a description of the method of providing congestion information on access roads based on the vehicle connectivity environment and a description of the data server and navigation terminal for providing congestion information on access roads based on the vehicle connectivity environment may be applied complementary to or in common with each other unless there are mutually exclusive circumstances. Accordingly, overlapping descriptions may be omitted.

Below, the main process of providing congestion information on road access roads based on the vehicle connectivity environment is described.

FIG. 11 is a flowchart illustrating a method of providing congestion information on road entrances and exits based on the vehicle connectivity environment according to an embodiment.

Referring to FIGS. 1 and 11, a method of providing congestion information on road access roads based on a vehicle connectivity environment according to an embodiment may be performed, for example, by the data server and navigation terminal 200 described above.

The method of providing congestion information regarding access roads based on vehicle connectivity environment may include an information request area determination operation (S100), a congestion information receiving operation (S200), a guidance point confirmation operation (S300), and a guidance information output operation (S400).

In the information request area determination operation (S100), the navigation terminal 200 of the device 50 for providing congestion information on access roads may determine whether or not to enter the information request area RA for the road entrance or exit during navigation execution (navigation program execution). For example, the navigation terminal 200 may determine whether to enter the information request area RA by comparing the entry position of the information request area RA with the driving position of the vehicle C8.

In the congestion information receiving operation (S200), the navigation terminal 200 may receive congestion information by requesting information regarding the entrance/exit route from the data server 100 when entering the information request area RA.

In the guidance point confirmation operation (S300), the navigation terminal 200 may determine the guidance area by comparing the length of the congested area CA included in the congestion information CI for the access road with the length of the guidance area GA, and may confirm entry into this determined guidance area.

In the guidance information output operation (S400), the navigation terminal 200 may output guidance information regarding the access road depending on whether to enter the guidance area or not.

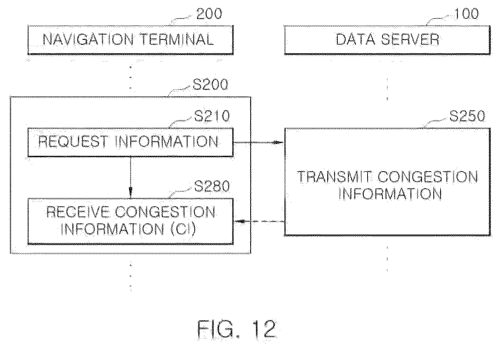

FIG. 12 is an example diagram of the congestion information transmission operation.

Referring to FIG. 12, the method of providing congestion information on access roads based on the vehicle connectivity environment may further include a congestion information transmission operation (S250).

In the congestion information transmission operation (S250), the data server 100 of the device 50 for providing congestion information on access roads may transmit congestion information CI including a pre-prepared congested area CA for the access road in response to a request for information regarding each entrance and exit route of the road from the navigation terminal 200.

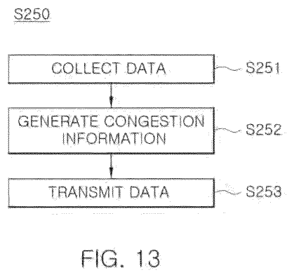

FIG. 13 is an example diagram of the detailed operation of the congestion information transmission operation of FIG. 12.

Referring to FIG. 13, the congestion information transmission operation (S250) may include a data collection operation (S251), a congestion information generation operation (S252), and a data transmission operation (S253).

In the data collection operation (S251), the data server 100 may collect first sensing information SI10 including location information on sensing target vehicles C1, C2, C3 and C4 that will pass through the access road and vehicle congestion determination information, from vehicles C5, C6 and C7 that will not pass through the access road among the vehicles positioned before the reference position of the access road.

In the congestion information generation operation (S252), the data server 100 may determine the congested area CA for the access road based on congested vehicles based on vehicle congestion determination information included in the first sensing information SI10, and may generate first congestion information CI10 including the congested area CA.

In addition, in the data transmission operation (S253), the data server 100 may transmit the first congestion information CI10 to the navigation terminal 200 in response to a request for information regarding the access road.

Additionally, in the congestion information generation operation (S252), the data server 100 may determine a congested vehicle on the access road based on location information for each of the sensing target vehicles C1, C2, C3 and C4 and vehicle congestion determination information included in the first sensing information SI10, and may determine the congested area CA based on the vehicle(s) determined to be congested.

For example, in the data collection operation (S251), the data server 100 may collect first sensing information including location information regarding the sensing target vehicle that will pass through the access road and vehicle congestion determination information, from sensing vehicles that will not pass through the access road, among vehicles before the reference position of the access road, or may collect second sensing information including location information regarding a driver's vehicle and vehicle congestion determination information from sensing vehicles that will pass through the access road.

Additionally, in the congestion information generation operation (S252), the data server 100 may determine the congested area with respect to the access road based on congested vehicles based on vehicle congestion determination information included in the first sensing information SI10, and generate first congestion information CI10 including the congested area information, or may determine the congested area with respect to the access road based on the second sensing information SI20, and generate second congestion information CI20 including the congested area.

For example, in the congestion information generation operation (S252), the data server 100 may determine a congested vehicle on the access road based on location information for each of the sensing target vehicles and vehicle congestion determination information included in the first sensing information SI10 and/or the second sensing information SI20, and may determine the congested area CA based on the vehicle(s) determined to be congested.

In addition, in the data transmission operation (S253), the data server 100 may transmit at least one of the first congestion information CI10 and the second congestion information CI20 as congestion information to the navigation terminal 200, in response to a request for information regarding the access roads, or may transmit congestion information based on the first congestion information CI10 and the second congestion information CI20 to the navigation terminal 200.

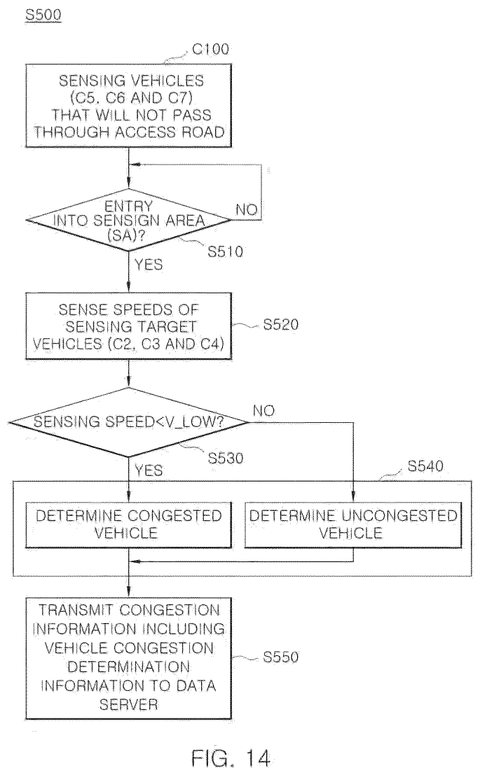

FIG. 14 is an example diagram of the entrance/exit road speed sensing operation.

Referring to FIG. 14, the method of providing congestion information on access roads based on vehicle connectivity environment may further include an access road speed sensing operation (S500).

In the access road speed sensing operation (S500), sensing vehicles C5, C6 and C7 (see FIG. 3) that will not pass through the access road, for example, the sensing vehicles C5, C6 and C7 (see FIG. 3) that sense the vehicle speed of vehicles C2, C3 and C4 that will pass through the access road, respectively may sense (S520) the speed of respective vehicles C2, C3 and C4 that will pass through the access road when entering the sensing area SA [km] (see FIG. 3) for the access road (S510), compare the sensed speed with the congestion reference speed V_low (S530), determine a congested vehicle or an uncongested vehicle according to the comparison result information (S540), and transmit congestion information CI, including this vehicle congestion determination information, to the data server 100 (S550). As an example, the reference speed V_low may be a preset speed to determine congestion.

For example, sensing vehicles C5, C6 and C7 (see FIG. 3) that will not pass through the access road may recognize the number of lanes of the road you are currently driving on, your vehicle's lane, and the lane connected to the access road, based on navigation information, information from the data server, and various sensing information from the vehicle, while navigation is running, and accordingly, may recognize the vehicle(s) that will pass through the access road.

For example, each of the sensing vehicles C5, C6 and C7 (see FIG. 3) that will not pass through the access road may sense speed of sensing target vehicles C2, C3 and C4, using the speed of the driver's vehicle and the relative speeds of each of the sensing target vehicles C2, C3 and C4 that will pass through the access road. As an example, the relative speed of the respective target vehicles C2, C3 and C4 may be obtained by continuously acquiring vehicle images of the target vehicles C2, C3 and C4 through a camera and obtained based on the relative position change in the driving direction for these consecutive vehicle images.

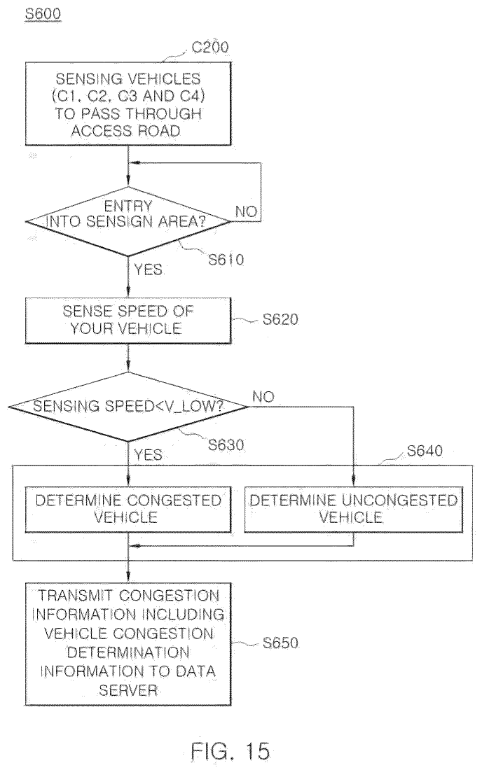

FIG. 15 is another example diagram of the access road speed sensing operation.

Referring to FIG. 15, the method of providing congestion information on access roads based on vehicle connectivity environment may further include an access road speed sensing operation (S600).

In the access road speed sensing operation (S500), the sensing vehicles C1, C2, C3 and C4 (see FIG. 1) that will pass through the access road, for example, the sensing vehicles C1, C2, C3 and C4 (see FIG. 1) that sense the vehicle speed of the driver's vehicle passing through the access road may respectively sense the speed of your vehicle (any one from C1 to C4) that will pass through the access road (S620) upon entering the sensing area SA [km] for the access road (S610), compare the sensed speed with the congestion reference speed V_low (S630), determine a congested vehicle or an uncongested vehicle depending on the comparison result information (S640), and transmit congestion information CI including this vehicle congestion determination information to the data server 100 (S650). As an example, the reference speed V_low may be a preset speed to determine congestion.

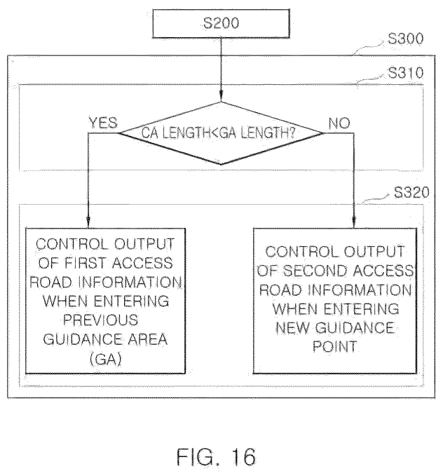

FIG. 16 is an example diagram of the guidance point confirmation operation in FIG. 11.

Referring to FIGS. 11 and 16, the guidance point confirmation operation (S300) may include a determination operation (S310) and a control operation (S320).

In the determination operation (S310), the navigation terminal 200 may determine whether the length of the congested area CA for the access road is less than the length of the guidance area GA (CA length<GA length).

In the control operation (S320), if the length of the congested area CA is less than the length of the guidance area GA, the navigation terminal 200 may control the output of the first access road guidance information when entering the guidance area GA. Alternatively, if the length of the congested area CA is greater than or equal to the length of the guidance area GA, the navigation terminal 200 may control the output of second access road guidance information at the point of entry into a new guidance area determined using the length of the congested area CA and the length of the guidance area GA.

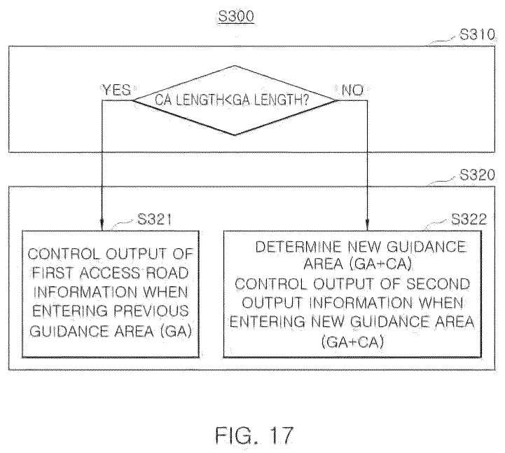

FIG. 17 is an example diagram of the control operation of FIG. 16.

Referring to FIGS. 16 and 17, in the control operation (S320), if the length of the congested area CA is greater than or equal to the length of the guidance area GA, the navigation terminal 200 may control the output of the second access road guide information at the point of entry into a new guidance area (for example, GA+CA) determined by adding the length of the congested area CA to the length of the guidance area GA.

According to the above-described operation, in the guidance information output operation (S400), if the length of the congested area CA is less than the length of the guidance area GA, the navigation terminal 200 may output the first access road guidance information when entering the guidance area GA, or if the length of the congested area CA is greater than or equal to the length of the guidance area GA, the navigation terminal 200 may output the second access road guidance information at the point of entry into a new guidance area (for example, GA+CA) determined by adding the length of the congested area CA to the length of the guidance area GA.

FIG. 18 is an example diagram of the congestion information update operation.

Referring to FIG. 18, the congestion information receiving operation (S200) may further include a congestion information update operation (S290).

In the congestion information update operation (S290), when the navigation terminal 200 receives congestion information CI including the congested area CA from the data server 100 (S280), the navigation terminal 200 may update the congestion information CI for the access road.

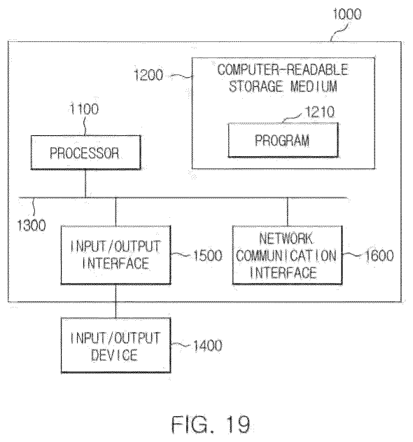

FIG. 19 is a block diagram of a computing device 1000 that may fully or partially implement a device and method of providing congestion information on an access road based on vehicle connectivity environment according to an embodiment.

As illustrated in FIG. 19, the computing device 1000 includes at least one processor 1100, a computer-readable storage medium 1200, and a communication bus 1300.

The processor 1100 may enable the computing device 1000 to operate according to the above-mentioned example embodiments. For example, the processor 1100 may execute one or more programs stored in the computer-readable storage medium 1200. The one or more programs may include one or more computer executable instructions, and the computer-executable instructions may be configured to enable the computing device 1000 to execute operations according to example embodiments, when executed by the processor 1100.

The computer-readable storage medium 1200 is configured to store computer-executable instructions or program code, program data, and/or other suitable forms of information. The program 1210 stored in the computer-readable storage medium 1200 includes a set of instructions executable by the processor 1100. In an embodiment, the computer-readable storage medium 1200 may be a memory (a volatile memory, such as random access memory, a non-volatile memory, or an appropriate combination thereof), one or more magnetic disk storage devices, optical disk storage devices, flash memory devices, other types of storage media that may be accessed by the computing device 1000 and store required information, or a suitable combination thereof.

The communication bus 1300 interconnects various other components of computing device 1000, including processor 1100 and computer-readable storage medium 1200.

The computing device 1000 may also include one or more input/output interfaces 1500 and one or more network communication interfaces 1600 that provide an interface for one or more input/output devices 1400. The input/output interface 1500 and the network communication interface 1600 are connected to the communication bus 1300. The network may be any one of cellular networks such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), or other cellular networks.

The input/output device 1400 may be connected to other components of the computing device 1000 through the input/output interface 1500. Examples of the input/output device 1400 may include a pointing device (such as a mouse or trackpad), keyboard, touch input device (such as a touchpad or touchscreen), or voice or sound input device, input devices such as various types of sensor devices and/or imaging devices, and/or output devices such as display devices, printers, speakers, and/or network cards. The illustrative input/output device 1400 may be included within the computing device 1000 as a component constituting the computing device 1000, or may be connected to the computing device 1000 as a separate device distinct from the computing device 1000.

Meanwhile, in embodiments of the present disclosure, a program for performing the methods described in this specification on a computer, and a computer-readable recording medium containing the program, may be included. The computer-readable recording medium may include program instructions, local data files, local data structures, and the like, singly or in combination. The media may be those specifically designed and constructed for the present disclosure, or may be those commonly available in the computer software field. Examples of computer-readable recording media may include magnetic media such as hard disks, floppy disks, and magnetic tapes, optical recording media such as CD-ROM and DVD, a specially configured hardware device to store and perform program instructions, such as ROM, RAM, flash memory, and the like. Examples of the programs may include not only machine language code such as that produced by a compiler, but also high-level language code that may be executed by a computer using an interpreter or the like.

As set forth above, according to some embodiments, the situation on the road entrances and exits of the road guided in the vehicle connectivity environment may be sensed in advance, and information regarding the queue on the access road may be provided before the queue begins due to congestion at the access road. Therefore, there may be an effect of preventing secondary accidents caused by unreasonable intervention late due to not knowing information regarding the queue at the access road in advance.

While example embodiments have been illustrated and described above, it will be apparent to those skilled in the art that modifications and variations could be made without departing from the scope of the present disclosure as defined by the appended claims.

What is claimed is:

1. A data server for providing congestion information based on a vehicle connectivity environment, the data server comprising:
a data collection module configured to collect sensing information including location information regarding a sensing target vehicle to pass through an access road and vehicle congestion determination information, from sensing vehicles sensing the access road among vehicles before a reference position of the access road;
a congestion information generation module configured to determine a congested area with respect to the access road based on the vehicle congestion determination information included in the sensing information, and generating the congestion information including congested area information; and
a data transmission module configured to transmit the congestion information in response to a request for information regarding the access road.

2. The data server of claim 1, wherein the data collection module includes at least one of a first data collection module configured to collect first sensing information including the location information regarding the sensing target vehicle to pass through the access road and the vehicle congestion determination information, from sensing vehicles that do not pass through the access road among the vehicles positioned before the reference position of the access road, and a second data collection module configured to collect second sensing information including location information regarding a driver's vehicle and the vehicle congestion determination information.

3. The data server of claim 2, wherein the congestion information generation module includes at least one of a first congestion information generator configured to determine the congested area with respect to the access road based on the vehicle congestion determination information included in the first sensing information and generate first congestion information including the congested area information, and a second congestion information generator configured to determine the congested area with respect to the access road based on the second sensing information and generate second congestion information including the congested area.

4. The data server of claim 3, wherein the data transmission module transmits at least one of the first congestion information or the second congestion information as the congestion information in response to the request for information regarding the access road, or transmits congestion information based on the first congestion information and the second congestion information.

5. The data server of claim 3, wherein the first congestion information generator is configured to determine a congested vehicle on the access road based on location information and vehicle congestion determination information for each of sensing target vehicles included in the first sensing information, and determine the congested area, based on vehicle(s) determined to be the congested vehicle.

6. The data server of claim 3, wherein the second congestion information generator is configured to determine a congested vehicle on the access road based on location information and vehicle congestion determination information for each of sensing vehicles included in the second sensing information, and determine the congested area, based on vehicle(s) determined to be the congested vehicle.

7. A navigation terminal for providing congestion information based on a vehicle connectivity environment, the navigation terminal comprising:
a data transceiver configured to request and receive congestion information including a congested area with respect to an access road from a data server when entering an information request area for the access road;
a guidance control module configured to determine whether a length of the congested area with respect to the access road is less than a length of a guidance area and control an output of access road guidance information at different points according to the length of the congested area, based on a determination result of the guidance control module; and
a guidance information output module configured to output guidance information regarding the access road according to control of the guidance control module.

8. The navigation terminal of claim 7, wherein the guidance control module includes:
a comparison module configured to compare the length of the congested area with respect to the access road and the length of the guidance area; and
a control module configured to control an output of first access road guidance information when entering the guidance area when the length of the congested area is less than the length of the guidance area as a result of the comparing, and control an output of second access road guidance information at a point of entry into a new guidance area determined using the length of the congested area and the length of the guidance area when the length of the congested area is greater than or equal to the length of the guidance area,
wherein the control module is configured to control the output of the second access road guidance information at the point of entry into the new guidance area determined by adding the length of the congested area to the length of the guidance area when the length of the congested area is greater than or equal to the length of the guidance area.

9. The navigation terminal of claim 7, wherein the data transceiver further includes a memory configured to update congestion information on a corresponding access road when the congestion information including the congested area is transmitted from the data server.

10. A vehicle comprising the navigation terminal of claim 7.

11. A method of providing congestion information based on a vehicle connectivity environment, the method comprising:
determining, by a data server, whether to enter an information request area for an access road;
receiving, by the data server, the congestion information by requesting information regarding the access road when entering the information request area;
determining, by the data server, a guidance area by comparing a length of a congested area included in the congestion information for the access road with a length of the guidance area, and confirming entry into the guidance area determined; and
outputting, by the data server, guidance information regarding the access road depending on an entry into the guidance area or not.

12. The method of claim 11, further comprising transmitting, by the data server, congestion information, including a congested area, prepared in advance for a corresponding access road, in response to a request for the congestion information for each access road by a navigation terminal.

13. The method of claim 12, wherein the congestion information transmission operation includes:
collecting, by the data server, sensing information including location information regarding a sensing target vehicle to pass through the access road and vehicle congestion determination information, from sensing vehicles sensing the access road among vehicles before reaching a reference position of the access road;
determining the congested area with respect to the access road based on the vehicle congestion determination information included in the sensing information, and generating the congestion information including congested area information; and
transmitting the congestion information in response to a request for information regarding the access road.

14. The method of claim 13, further comprising collecting first sensing information including the location information regarding the sensing target vehicle to pass through the access road and the vehicle congestion determination information, from sensing vehicles that do not pass through the access road among the vehicles positioned before the reference position of the access road, or collecting second sensing information including location information regarding a driver's vehicle and the vehicle congestion determination information from sensing vehicles to pass through the access road.

15. The method of claim 14, further comprising:
determining the congested area with respect to the access road based on the vehicle congestion determination information included in the first sensing information and generating first congestion information including the congested area information, or
determining the congested area with respect to the access road based on the second sensing information and generating second congestion information including the congested area.

16. The method of claim 15, further comprising transmitting at least one of the first congestion information and the second congestion information as the congestion information in response to the request for information regarding the access road, or transmitting congestion information based on the first congestion information and the second congestion information.

17. The method of claim 11, further comprising sensing, by respective sensing vehicles sensing a vehicle speed on the access road, speeds of respective vehicles advancing on the access road or a speed of a driver's vehicle when entering a sensing area for the access road, comparing a sensed speed with a congestion reference speed, determining a congested vehicle or an uncongested vehicle depending on comparison result information, and transmitting the congestion information including determination information on the congested vehicle to the data server.

18. The method of claim 11, further comprising:
a determination operation of determining whether the length of the congested area with respect to the access road is less than the length of the guidance area; and
a control operation of controlling an output of first access road guidance information when entering the guidance area when the length of the congested area is less than the length of the guidance area, and controlling an output of second access road guidance information at a point of entry into a new guidance area determined using the length of the congested area and the length of the guidance area when the length of the congested area is greater than or equal to the length of the guidance area.

19. The method of claim 18, further comprising controlling the output of the second access road guidance information in a new guidance area determined by adding the length of the congested area to the length of the guidance area, when the length of the congested area is greater than or equal to the length of the guidance area.

20. The method of claim 11, further comprising updating the congestion information for a corresponding access road when a navigation terminal receives the congestion information including the congested area from the data server.
